(19) United States
(12) Patent Application Publication
(10) Pub. No.: US 2011/0219968 A1
(43) Pub. Date: Sep. 15, 2011

(54) Printing Unit with Curved Sealing Doctor Blade

(76) Inventor: Christian Fogh-Hansen, Bjert (DK)

(21) Appl. No.: 13/130,761

(22) PCT Filed: Nov. 20, 2009
(86) PCT No.: PCT/DK2009/050308

§ 371 Date: Jun. 1, 2011

(30) Foreign Application Priority Data
Nov. 26, 2008 (DK) PA 2008 01668

(51) Int. Cl. B41F 9/10

(52) U.S. Cl. 101/157

(57) ABSTRACT

A printing unit with a rotary roller and an ink chamber with an elastic sealing doctor blade (2) which in a curve with decreasing curvature extends from a holder (6) to a tangential point of contact on the surface of the rotary roller. A packing follows the curvature in order to seal between the sealing doctor blade and the ink chamber.

### FIELD OF THE INVENTION

The present invention concerns a printing unit with a rotary roller and an ink chamber with a sealing doctor blade in contact with the surface of the rotary roller in a contact area, where the sealing doctor blade is secured in a holder and is resiliently deformed to a curve between the holder and the contact area.

### BACKGROUND OF THE INVENTION

In EP 401 250 is disclosed a doctor blade device which is represented in FIG. 1. The device includes a chamber bar with a U-shaped doctor blade chamber 3 with bottom 3A and sides 3B and 3C which during operation contain ink for a printing unit with a screen roller (not shown) which is in contact with the ink in the chamber 3. Two doctor blades 1, 2 are clamped to the chamber 3 by rails 5, 6, having the function of sealing against the screen roller, its surface being in contact with the ink in the chamber 3. Ink may be conducted into the chamber 3 via channels 8. Two channels 8 are shown, one for each part chamber in the chamber 3, wherein the part chambers are provided by delimiting by means of a packing 4 inside the chamber and a packing 4 at the end of the chamber. The packing 4 has a concave shape 4A for bearing against the screen roller.

A packing of this type is reproduced in FIG. 2 which is a copy of the U.S. design D 488,503. This packing has a central section 10 with a rail 7 of a hard material for bearing against the screen roller for enhanced sealing. The doctor blade is further supported by a number of straight elastomeric lips 9. These elastomeric lips 9 are traditionally largely straight and with an angle approximately corresponding to the angle of contact of the doctor blade against the screen roller.

The two doctor blades 1, 2 depicted in FIG. 1 have different functions. The first doctor blade 1 has an edge pointing against the direction of rotation of the roller, called a positive doctor blade or active doctor blade, which scrapes excess ink off the roller during rotation, where the screen on the roller passing through the chamber 2 have been filled with ink. The second doctor blade 2 which has an edge pointing in the same direction as the direction of rotation is called a passive doctor blade or sealing doctor blade which has the primary function of sealing against the ink running out of the chamber 3.

During the printing process, where the screen roller rotates at a high speed, e.g. at a speed of more than 120 m/min, or even more than 200 in/min, not all ink is deposited, and ink is carried on all the way round by the rotary roller. This ink has a tendency of being collected at the outer side of the sealing doctor blade. The doctor blades typically used with a thickness of 0.3 mm are not flexible enough in order to let the ink be carried into the chamber again.

Therefore, it has been attempted to use thinner sealing doctor blades with a thickness of about 0.10 mm such that it is deformed into a curve, where the edge of the doctor blade touches the tangent of the rotary roller at a smaller angle, or is even disposed in parallel with the tangent. The problem is discussed in the Japanese patent publication JP 2000 117942 by Otsuka Norihiro, where a curving sealing doctor blade is also shown.

Such a deformation of the sealing doctor blade implies that the sealing doctor blade is no longer in contact with the above described packing 4 if this has a straight edge 9 as shown in FIG. 2.

In order to eliminate this disadvantage, in commercial products the packings 4 have been changed to have a different shape as shown in FIGS. 3a and 3b, where in continuation of the central section with the rail 7 there are provided a first straight elastomeric lip 9 and a second curving elastomeric lip 9′ at each their end of the central section 10. The second lip 9′ curves in against the central section 10, where at the transition point 15 it has tangential direction relative to the screen roller in order to support tangential contact of the sealing doctor blade against the rotary roller. The curvature of the lip 9′ is increased from the outer edge 11 where the sealing doctor blade leaves the holder in direction against the central section 10. With reference to the auxiliary line 12, it appears that the curvature actually changes such that the curvature is greater in the second half 14 of the lip 9′ than in the first half 13 of the lip 9′. In spite of this improvement compared with other prior art, it has not been possible to provide a continually exact sealing between the sealing doctor blade.

In other descriptions of printing rollers from the prior art it has also been indicated that a sealing may have a curving path with an approximately tangential contact with rotary rollers, see e.g. JP 2003 080674 by Kudo Yoshihiko.

However, in the prior art there is no disclosure or indication of a solution with regard to designing the above described commercially available packings in such a way that the observed leaks are avoided. Generally there is no description of how the sealing doctor blade is to run in order to have the optimal shape. A need for further improvement in this regard therefore exists.

### OBJECT OF THE INVENTION

It is the object of the invention to provide a printing unit with a rotary roller and a doctor blade chamber where the sealing doctor blade has a course that ensures the best possible sealing with packings. Moreover, it is the object to provide a packing between the sealing doctor blade and the chamber, where the chamber interacting with the sealing doctor blade is designed with the object of best possible sealing.

### DESCRIPTION OF THE INVENTION

This object is achieved by the subsequent printing unit with a rotary roller and an ink chamber with a sealing doctor blade in contact with the surface of the rotary roller in a contact area. The sealing doctor blade is secured in a holder and is resiliently deformed into a curve between the holder and the contact area, where the curve has a curvature which is greater at the holder than at the contact area at the rotary roller. For example, the curve has a first half part bordering on the holder and a second half part bordering on the rotary roller, where the curvature is greater in the first half part.

It has appeared that a far better sealing can be achieved if the curvature of the packing on FIG. 3 described in the introduction is adapted such that the curvature of the curve decreases from the holder to the contact area, preferably decreasing evenly, instead of increasing. Intense studies of the problem has revealed that the sealing doctor blade that the packing on FIG. 3 described in the introduction is forcibly deformed to such a degree that it will tend not to follow the curvature on the packing. However, the sealing doctor blade adapts to the curvature of the packing in a far better way by a curvature form which decreases from the holder, particularly if the curvature is linearly or approximately linearly decreasing.

In that way is ensured that the sealing doctor blade has a uniformly curving shape along the entire length of the ink chamber. Furthermore, this shape is maintained by the new adapted packings.

Typically, the sealing doctor blade is secured in a holder disposed at an acute angle, for example 30 degrees, relative to the tangent of the rotary roller in the contact area. The angle is preferably between 5 and 50 degrees, preferably between 15 and 40 degrees, and most preferably between 20 and 35 degrees. The sealing doctor blade curves from the holder in against the rotary roller where it is in contact with the rotary roller at a very small angle, such as between 0 and 10 degrees, preferably between 0 and 5 degrees, or actually approximately tangentially. In that way, ink residue on the rotary roller, e.g. a screen roller, will rotate past the sealing doctor blade and into the ink chamber again. In that way back-blading is avoided where the sealing doctor blade shaves ink off such that it does not return to the chamber during rotation.

Observations have been made of the advantage of the tangential or approximately tangential path of the sealing doctor blade at the rotary roller, namely of the fact that by running at relatively high speed, which means above 120 m/min, an ink film is built up between the rotary roller and the sealing doctor blade such that the sealing doctor blade actually does not touch the rotary roller. The phenomenon is analogous to aquaplaning. This means that the friction between the sealing doctor blade and the rotary roller is very small, reducing wear considerably. In spite of the lack of direct contact between the sealing doctor blade and the rotary roller by the building of the ink film, the expression “contact area” is maintained and is to be understood as the area where there is the smallest spacing between sealing doctor blade and the rotary roller.

If the doctor blade in the holder is disposed at a substantial angle with the tangent, e.g. 30°, the doctor blade has to be relatively easily flexed. By the typically used types of steel, the thickness in that case is preferably between 0.04 mm and 0.15 mm, curving over a distance between 25 mm and 50 mm from the holder and to the contact area.

By the prior art doctor blades with a thickness of 0.3 mm, it is not practically possible to produce a bend of 30° over 30 mm. The force from the rotary roller required to produce such a bend will destroy the surface of the roller, and there is a risk that the doctor blade will break. By using doctor blades with a material thickness of more than 10 mm, it is therefore preferred that the angle of the holder is less than 30°, preferably less than 20°. And if the doctor blade is more than 0.15 mm thick, the angle of the holder is preferably to be less than 15°.

In a practical embodiment, the holder of the sealing doctor blade is a rail arrangement which is provided on an ink chamber. A packing is used for sealing between the curving sealing doctor blade and the bottom of the chamber. The packing then has a curving central section for contact against the rotary roller and a lip in continuation of the central packing for supporting the sealing doctor blade from the holder and to the contact area. The lip is designed with a curve which follows the curvature of the sealing doctor blade as indicated above.

For example, the sealing doctor blade has a curve with a first half part bordering on the holder, and a second half part in continuation of the central section, where the curvature is greatest in the first half part. The curvature is then greater at the holder than at the contact area at the rotary roller. By designing the lip with a curve, the curvature of which increasing in direction away from the central section, there is achieved a far better sealing than by previous packings where the curvature was decreasing. Preferably, the curvature increases evenly from the central section, e.g. linearly or approximately linearly.

### DESCRIPTION OF THE DRAWING

The invention will be described in more detail with reference to the drawing, where:

FIG. 1 shows a doctor blade chamber according to prior art from EP 410 250;

FIG. 2 shows a packing according to prior art from U.S. D 488,503;

FIG. 3 shows a commercially available packing in a) perspective view and b) from the side;

FIG. 4 shows a schematic drawing of an example of a printing unit according to the invention;

FIG. 5 shows the angle between the sealing doctor blade and the tangent in an enlarged perspective view;

FIG. 6 shows a packing according to the invention in a) perspective view and b) from the side; and

FIG. 7 shows a possible course of a doctor blade under bending.

### DETAILED DESCRIPTION OF THE INVENTION

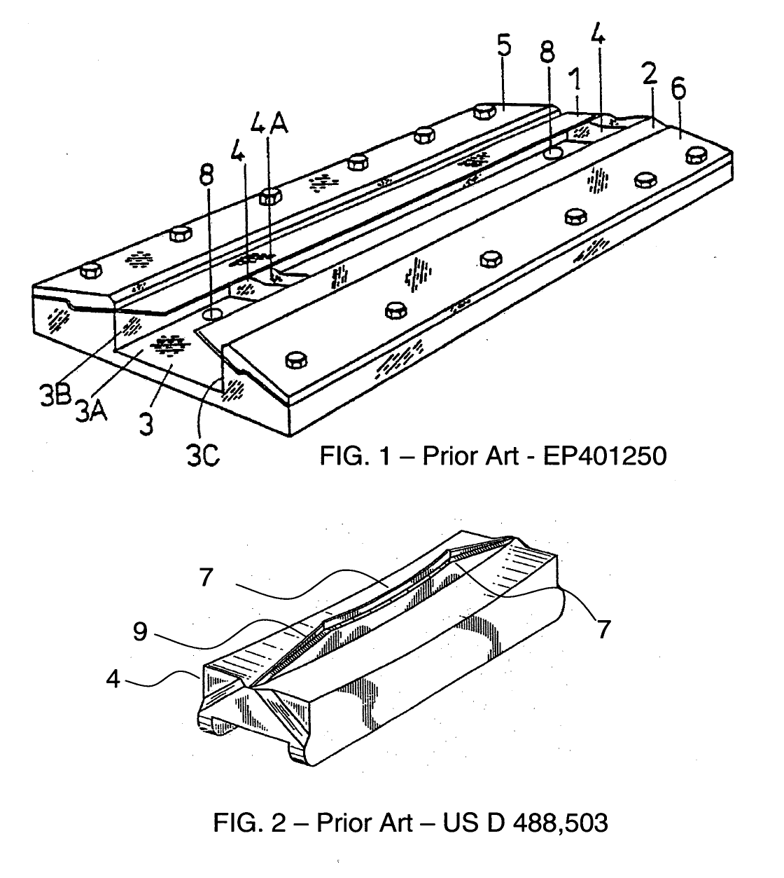

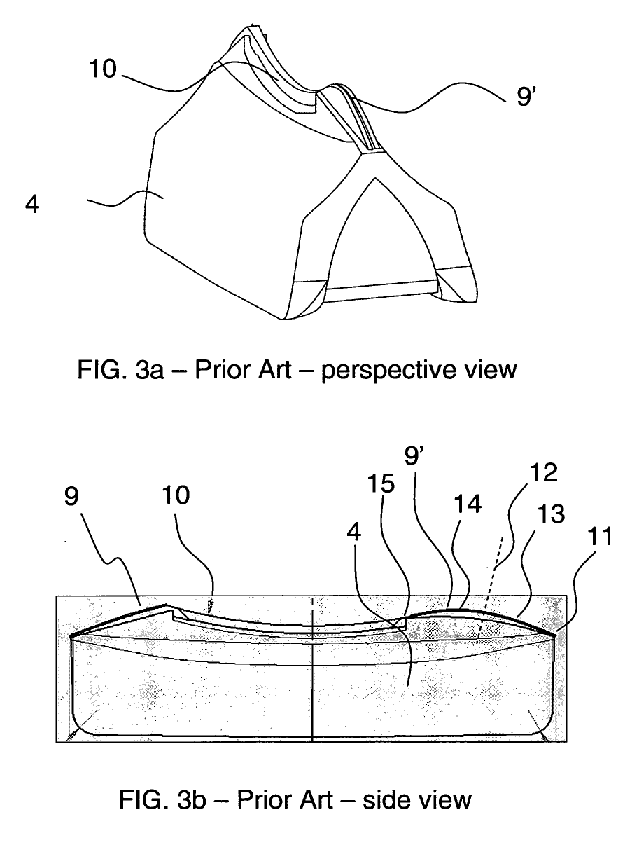

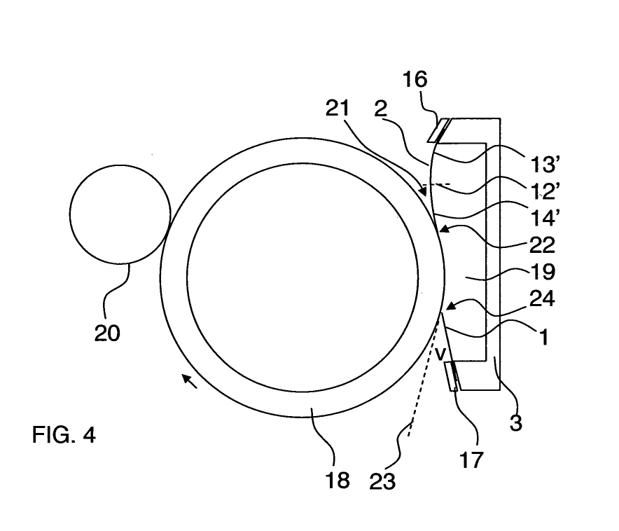

FIGS. 1, 2 and 3 show a doctor blade chamber and packings according to prior art as described in the introduction.

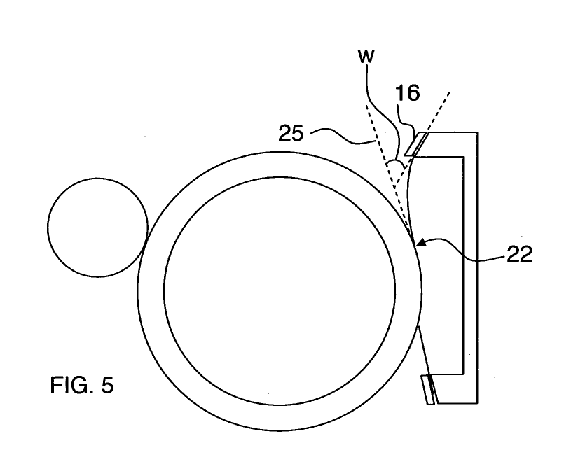

FIG. 4 shows a printing unit according to the invention. The printing unit includes a rotary roller 18, preferably a screen roller which according to the Figure rotates clockwise and in contact with a doctor blade chamber 3 which in its cavity 19 contains ink which by rotation is absorbed by the rotary roller 18.

The active doctor blade 1 which is secured to the chamber 3 by a rail arrangement 17 scrapes excess ink off the rotary roller 18. The ink is transferred to another roller 20 before the finished print is transferred to paper. The active doctor blade 1 is secured in a holder 17 at an angle ν with the tangent 23 in the contact point 24. This angle ν is typically 30-35°.

Ink not transferred to the other roller 20 is carried into the cavity 21 between sealing doctor blade 2 and the rotary roller 18. As the sealing doctor blade 2 in the contact area 22 is tangential or approximately tangential to the rotary roller 18, the excessive ink is easily drawn into the cavity 19 of the doctor blade chamber 3. A film is thereby formed between the sealing doctor blade 2 and the rotary roller 18, reducing friction and diminishing wear on sealing on the sealing doctor blade 2 as well as the rotary roller 18.

The tangential contact between sealing doctor blade 2 and the rotary roller 18 is achieved by elastic deformation of the sealing doctor blade 2. The sealing doctor blade 2 curves from the holder 16 with a curvature that is greater at the holder 16 than in the contact area 22. The auxiliary line 12 divides the length of the sealing doctor blade 2 between the holder 16 and the contact area into two parts, and it is illustrated that the curvature in the first half 13′ is greater than in the second half 14′.

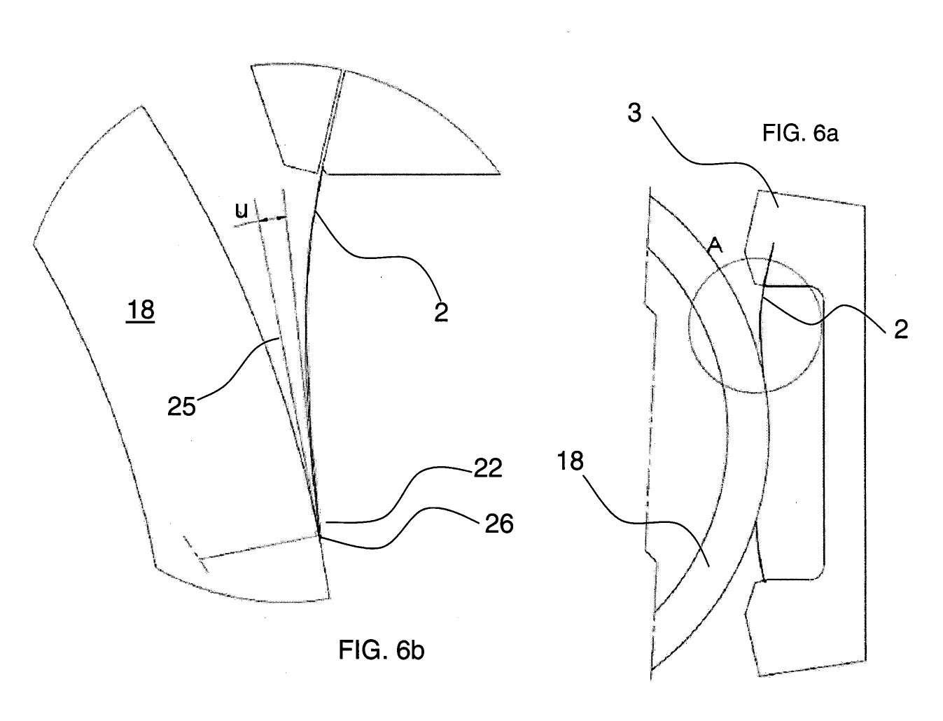

FIG. 5 illustrates the angle w between the tangent 25 in the contact area 22 of the sealing doctor blade 2 and the holder 16. For the sake of illustration, the angle w on the drawing is larger than it typically would be in reality. Even though this acute angle in principle may assume values between 5 and 50 degrees, it will typically be between 20 and 35 degrees. The deflection depends on the elasticity constant and thickness of the sealing doctor blade, as the latter value puts a limit to how much it can be deformed without damaging the rotary roller due to too large pressure. By thicker doctor blades, the angle is less than for thin doctor blades. The pressure of the sealing doctor blade on the rotary roller is to be adapted to the condition that an ink film is able to be formed between the sealing doctor blade and the rotary roller. This film may extend several millimetres along the length of the sealing doctor blade, why it is more like an extended contact area than a linear contact area along the rotary roller.

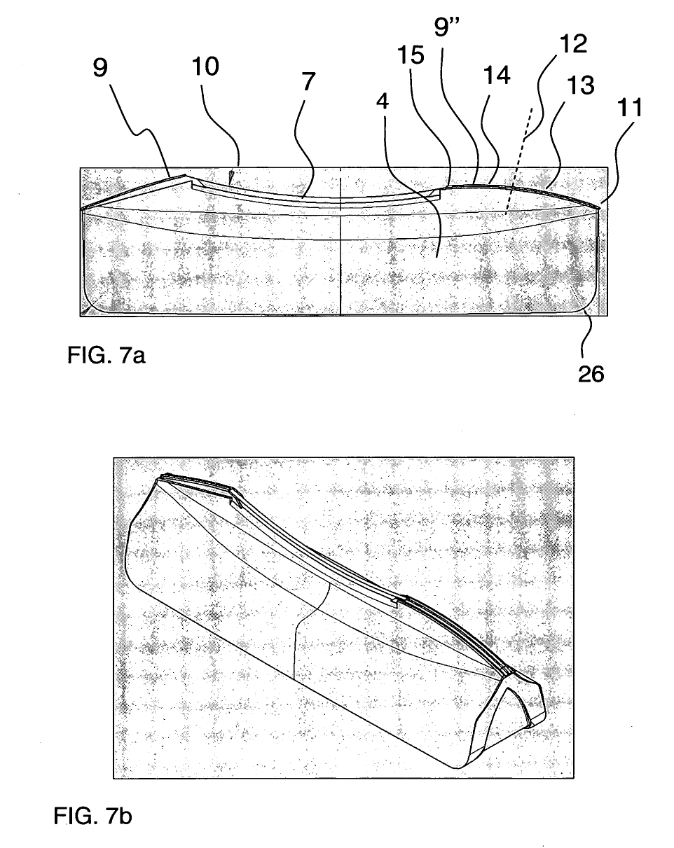

FIG. 6a shows the doctor blade chamber and part of the rotary roller 18 where the circular detail A is reproduced enlarged in FIG. 6b. By the given bending, the edge 26 of the sealing doctor blade 2 touches the rotary roller in a line. During operation, the sealing doctor blade will, however, be lifted off the rotary roller due to the ink transported into the chamber 3 by passage between the sealing doctor blade 2 and the rotary roller 18. The linear contact area 22 is therefor changed during operation into a contact area extending across several millimetres. The sealing doctor blade will typically be adjusted in relation to the rotary roller such that this contact area with ink film is located at the edge 26 of the sealing doctor blade 2. However, this is not strictly necessary as it has appeared that there is no great difference as to whether the line of contact between the sealing doctor blade and the rotary roller is at the edge 26 of the sealing doctor blade 2 or at some distance within the sealing doctor blade, i.e. the sealing doctor blade continues past the theoretical line of contact as long as a friction-reducing ink film is formed between the sealing doctor blade and the rotary roller during operation.

In the shown drawing, the angle between the tangent 25 and the sealing doctor blade 2 in the contact area 22 is greater than zero degrees. The angle is typically kept between 0 and 5 degrees in order to ensure easy passage of the ink past the sealing doctor blade 2 and back into the chamber 3.

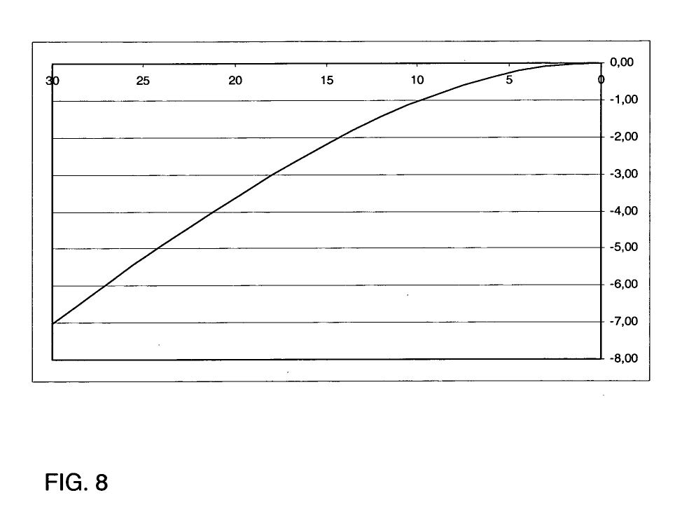

FIG. 7 is a schematic drawing of a packing for a chamber as on FIG. 4. FIG. 7a is a side view, whereas FIG. 7b shows the packing in perspective view. The packing 4 has an elastic socket 26 on which is provided a central section 10 with a rail 7 for bearing against the rotary roller. The rail has curvature which under pressure against the rotary roller corresponds to the curvature of the roller. The rail is adapted such that it follows the curvature of the rotary roller when the packing is pressed against the rotary roller and is slightly deformed; the packing is typically compressed half a millimetre by this pressure why the rail why the rail is not necessarily provided the exact same curvature as the rotary roller when the packing is pressed against the rotary roller.

Extending from each their end of the central section 10, there is provided a first, straight elastomeric lip 9 and a second curving elastomeric lip 9″. The second lip 9″ curves in against the central section 10, where at the transition point 15 it has tangential direction relative to the rotary roller in order to support a tangential contact of the sealing doctor blade against the rotary roller. The curvature of the lip 9″ increases from the central section 10 towards the outer edge 11 where the sealing doctor blade leaves the holder. With reference to the auxiliary line 12, it appears that the curvature actually changes such that the curvature is greater in the first half 13 of the lip 9′ than in the second half 14 of the lip 9′. This course ensures a far better sealing against the sealing doctor blade than by the prior art system.

Sealing doctor blades can be made of polymer, e.g. with a fibre reinforcement. In many cases, however, doctor blade steel is used. Doctor blade steel is typically provided in long webs rolled up on a coil and with a width of typically 35 or 50 mm. Doctor blade steel is made of resilient knife steel and is flat when not loaded. Such a 50 mm wide doctor blade steel is squeezed with the first 15 mm into the holder, where a rail presses the doctor blade steel against the chamber as also shown in FIG. 1. The 35 mm protruding outside the holder is thus curving when the free edge of the doctor blade steel is pressed against the rotary roller 18. It is preferred that the free edge of the sealing doctor blade 2 follows the rotary roller 18 tangentially or approximately tangentially, preferably at an angle with the tangent in the contact area less than 5 degrees and most preferred less than 2 degrees. Then an ink film will be formed between the rotary roller and the edge area of the sealing doctor blade, extending a few millimetres, typically between 2 and 5 mm, from the edge of the sealing doctor blade.

FIG. 8 shows a preferred curve for a doctor blade with a thickness of 0.1 mm. The abscissa indicates the distance of the doctor blade from the holder, and the ordinate shows the deflection of the edge of 7 mm and the preferred course of the curve. The curve proceeds substantially as u(x)=k₁−k₂x+k₃x³. In the constants, the force from the rotary roller upon the edge of the doctor blade, the elasticity constant of the material and the moment of inertia form part. In the shown course of the curve, the curvature, which is the second derivative of the curve function, decreases linearly by the distance from the holder.

The shown curve is theoretically calculated with a 7 mm deflection of a 0.1 mm thick doctor blade at an action of force of 23.4 N at a distance L=30 mm from the holder of the doctor blade. The course of the curve at a distance x from the holder of the doctor blade may be approximated to u(x)=−K*[(L−x)/L−(L−x)³/3L³]. K is then given by K=P*I²/2E, where P is the force, I the moment of inertia, and E is the modulus of elasticity which for steel is typically 210000/mm².

The dependence of the thickness of the steel is great with regard to the force between the edge of the doctor blade and the rotary roller. For example, under the same conditions the above force of 23.4 N will be changed to 90 N by doubling the thickness to 0.2 mm, and even to an unacceptably great force of more than 300 N at a thickness of 0.3 mm.

1. A printing unit with a rotary roller and an ink chamber with a sealing doctor blade (2) in contact with the surface of the rotary roller (18) in a contact area (22), where the sealing doctor blade is fixed in a holder (16) and is resiliently deformed into a curve between the holder and the contact area, wherein the curve has a curvature which is greater at the holder than at the contact area on the rotary roller.

2. A printing unit according to claim 1, wherein the curve has a first half part (13′) bordering on the holder (16), and a second half part (14′) bordering on the rotary roller (18), where the curvature is greatest in the first half part.

3. A printing unit according to claim 1, wherein the curvature of the curve decreases from the holder (16) to the contact area (22).

4. A printing unit according to claim 1, wherein the curvature of the curve approximately decreases evenly from the holder (16) and to the contact area (22).

5. A printing unit according to claim 1, wherein the sealing doctor blade (2) is secured in a holder disposed at an acute angle (w) between 20 and 35 degrees relative to the tangent (25) of the rotary roller (18) in the contact area (22).

6. A printing unit according to claim 1, wherein the sealing doctor blade (2) in the contact area (22) is disposed at an angle between 0 and 5 degrees relative to the tangent of the rotary roller (18).

7. A printing unit according to claim 1, wherein the sealing doctor blade (2) has a thickness between 0.04 and 15 mm and curves over a distance between 25 mm and 50 mm from the holder (16) and to the contact area (22).

8. A printing unit according to claim 1, wherein the holder of the sealing doctor blade (2) is a rail arrangement (16) which is provided on an ink chamber, where a packing (4) is provided for sealing between the sealing curve of the doctor blade (2) and the chamber bottom (3A), where the packing (4) has a curving central section (10) for contact against the rotary roller (18) and a lip (9″) in continuation of the central section for supporting the sealing doctor blade from the holder and to the contact area, where the lip is formed with a curve for following the curve of the sealing doctor blade, where the curve has a curvature which is greater at the holder than at the contact area on the rotary roller.

9. A packing for use in a printing unit according to claim 8, wherein the packing (4) has an elastic socket (26) for sealing disposition in the bottom (3A) of the chamber (3) and a curving central section (10) on this socket for contact against the rotary roller, where in continuation of this central section there is provided an elastomeric lip (9″) for supporting the curving sealing doctor blade (2) from the holder (6) to the contact area, where the lip is formed with a curve, the curvature of which increasing in direction away from the central section.

10. A packing according to claim 9, wherein the curvature of the lip (9″) increases evenly from the central section (10).

11. A packing according to claim 9, wherein the lip (9′) of the packing has a curve with a first half part (13) bordering on the holder (16), and a second half part (14) in continuation of the central section (10), where the curvature is greatest in the first half part.
